(19) United States
(12) Patent Application Publication
(10) Pub. No.: US 2026/0203644 A1
(43) Pub. Date: Jul. 16, 2026

(54) PERFORMANCE OF SECURED MODELS USING HETEROGENEOUS DATASETS VIA DYNAMIC LOSS FUNCTIONS

(71) Applicant: Capital One Services, LLC, McLean, VA (US)

(72) Inventors: Rongwen WU, McLean, VA (US); Kareem EL-GOHARY, Brooklyn, NY (US); Chandramouli BANERJEE, Philadelphia, PA (US); Heng SUN, McLean, VA (US); Yigit ALTINTAS, Bronx, NY (US); Tangxin JIN, Tysons Corner, VA (US); Hanmo LI, Tysons, VA (US)

(73) Assignee: Capital One Services, LLC, McLean, VA (US)

(21) Appl. No.: 19/019,384

(22) Filed: Jan. 13, 2025

(51) Int. Cl. G06N 20/00

(52) U.S. Cl. CPC G06N 20/00

(57) ABSTRACT

Methods and systems are described herein for improving the performance of machine learning models using heterogeneous datasets via dynamic loss functions. For example, the system may determine whether a dataset to be used to train a machine learning model comprises a heterogeneous dataset characteristic. In response to the dataset comprising the heterogeneous dataset characteristic, the system selects a dynamic loss function, wherein the loss function comprises a hyperparameter that is based on segments of a segmented dataset distribution. The system may then segment the dataset and generate a set of dynamic hyperparameter values, where each hyperparameter value corresponds to a respective data segment of the segmented dataset. The system may then provide the dataset to a machine learning model to train the machine learning model using the dynamic loss function.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

These technical problems may present an inherent problem with attempting to use an artificial intelligence-based solution to accurately predict outcomes for data that contains idiosyncrasies, such as outliers, or that demonstrate a heterogeneous characteristic. Currently to address this issue, a common approach is to utilize generic loss functions to mitigate the influence of the outlier during the model training process. However, the currently utilized generic loss function are not equipped to make predictions on datasets with uneven or distinct heterogeneity across segments of the data, failing to resolve the issues of poor predictive performance.

### SUMMARY

Methods and systems are described herein for novel uses and/or improvements to artificial intelligence applications. As one example, methods and systems are described herein to improve the performance of machine learning models when training such models on heterogeneous datasets via dynamic loss functions.

During machine learning model training, a training dataset is provided to the machine learning model such that the machine learning model learns various relationships between the features of the dataset to generate an output (e.g., a prediction, forecast, classification, etc.). In supervised machine learning model training, features of the dataset may be labeled with contextual information to allow the machine learning model to learn these relationships (e.g., patterns within the dataset). During supervised machine learning model training, as part of or in addition to the training dataset, a known output value that corresponds to features of the training dataset may be used to determine a loss value. For example, such loss value may be calculated using a loss function based on the known output value and a predicted value (e.g., as generated by the machine learning model). The loss value may then be used to update one or more parameters of the machine learning model (e.g., weights, biases, etc.) to improve the machine learning model's overall performance on the dataset, where the machine learning model's performance is measured using one or more performance metrics that measure the model's accuracy of generating a “correct” output based on input data.

As machine learning model performance is an important factor to be considered during machine learning model training, over time a plethora of loss functions aimed at improving machine learning model performance have been developed. Existing systems aim to minimize machine learning model errors by using existing predefined loss functions. However, different loss functions may impact the machine learning model's performance, and as such, selecting an appropriate loss function for a given application is paramount during machine learning model training. Dataset characteristics of the training data may not only influence the overall machine learning model performance (e.g., output accuracy), but also may influence which loss function should be used to achieve optimal machine learning model prediction performance.

One dataset characteristic that contributes directly to the machine learning model's overall performance is whether the training dataset exhibits a heterogeneous dataset characteristic. As an example, heterogeneous datasets may include datasets that have many outlier values which directly impact the model's ability to determine meaningful relationships or other patterns within the data. For example, in the context of training machine learning models that utilize a “boosting” technique, such as gradient boosting machines, failing to account for or mitigate the heterogeneous dataset characteristics causes the machine learning models to place more weight on the outlier observations within the training data. This error is compounding due to the errors (as determined by a loss function) that are determined in one step of training influences the machine learning models fit to the training data in the next step-thereby causing the machine learning model to learn erroneous relationships or patterns within the data, decreasing overall model performance.

To overcome these technical challenges, existing systems may exclude outliers from the dataset (e.g., training dataset) in a process known as trimming, or by replacing outliers with a percentile of a trimmed outlier value in a process known as winsorization. In either case, the distribution of the data entering the model is directly modified. Due to the direct modification of the dataset, valuable data within the dataset may be inadvertently lost when attempting to improve overall machine learning model prediction performance, thereby inadvertently working against the problem they are trying to solve.

To overcome the technical challenges associated with trimming and winsorization, other existing systems may modify existing loss functions by setting a parameter that demarcates a “threshold” between regular and outlier observations, thus giving less weight to the outliers. For example, the Huber Loss function may provide this parameter to give less weight to values within the dataset that fall outside the predefined threshold value, thereby balancing the impact of outliers present within the training data while forgoing a direct modification to the dataset. Such Huber loss function sets this parameter to be a predefined value (e.g., quantile value, such as a 95^{th} percentile of a target variable). This parameter is then calculated across the entire data distribution. For example, where the parameter is set to the 95^{th} percentile, data points of the target variable of the training dataset that are greater than or equal to the 95^{th} percentile with respect to all data points of the target variable are then treated as outlier values. Values that are treated as outlier values are then given less weight, which in turn mitigates the impact of such outlier values without directly modifying the dataset.

However, while the Huber Loss function may generally improve machine learning model performance by providing less weight to these outlier values, such loss function creates a technical problem with respect to machine learning model performance (e.g., forecasting performance, classification performance, etc.) at the segment level of the dataset (e.g., sub-segments of the dataset). For instance, due to the parameter being a single, predefined, uniform, threshold value with respect to the entire training data distribution of the training dataset, in cases where the outliers are found at different segments of the dataset, and vary within such segments, the uniform threshold value may cause the machine learning model to result in underfitting or over fitting for respective sub-segments of the dataset.

For example, where a target variable within a training dataset has a large amount of outlier values, when the existing Huber Loss function is applied, the threshold (e.g., parameter) may be set to the 95^{th} percentile of the target variable values across the entire dataset. However, when considering the segment level of the dataset, the definition of what constitutes outlier value may vary with respect to each other sub-segment of the dataset. For example, a first sub-segment may be associated with outlier values being values that are greater than or equal to 500 (of a given metric), and a second sub-segment may be associated with outlier values being values that are greater than or equal to 4000 (of a given metric). Using the existing Huber Loss function, the threshold may be set to 800 (of a given metric) as the uniform threshold value is determined based on the entire dataset. As such, when leveraging such loss function, the machine learning model would overfit patterns within the data of the first sub-segment, and underfit patterns within the data of the second sub-segment. This directly impacts the accuracy and performance of the machine learning model when supplied new data to generate an output (e.g., a prediction, classification, forecast, etc.) as, if the new data includes a value that falls within either sub-segment, the generated output is erroneous due to the presence of the respective underfitting or overfitting of the machine learning model with respect to these sub-segments. Moreover, due to respective underfitting or overfitting across these sub-segments, overall machine learning model performance is negatively impacted as these erroneous fits may be aggregated across the entire dataset, thereby causing inaccurate machine learning model predictions to be generated.

Moreover, existing systems may further employ a multitude of machine learning models to account for segment-level outliers, where each model is trained on a different sub-segment of the dataset (e.g., training dataset). However, doing so increases utilization of computational resources (computer processing and memory resource allocation) due to each model needing to be created and trained on the respective segments of the data. When training data is limited (e.g., a small sample size), leveraging this technique creates a series of overfit or underfit machine learning models due to limited size of the dataset-thereby counteracting the problem they are trying to solve, thereby requiring one or more optimization methods to be performed. Moreover, to generate a new machine learning model output (e.g., prediction, forecast, classification, etc.) based on each of the uniquely configured models requires another component, be a machine learning model or multiplexer, to aggregate the outputs of the different, uniquely trained machine learning models-further causing an increase in computational resources.

To overcome these technical deficiencies in adapting artificial intelligence models (e.g., machine learning models), methods and systems disclosed herein utilize a dynamic loss function that is sensitive to varying segment-level outliers by (i) determining a set of dynamic hyperparameter values that each correspond to a respective sub-segment of the dataset and (ii) using the determined set of dynamic hyperparameter values with the dynamic loss function during machine learning model training, thereby reducing biased machine learning model outputs from a single model. For example, the system may first determine whether a received dataset for training a machine learning model exhibits a heterogeneous characteristic. In response to determining that the received dataset exhibits the heterogeneous characteristic, the system may select a dynamic loss function that is optimized to process heterogeneous datasets by using a dynamic hyperparameter that is adaptable to each segment of a segmented dataset distribution.

For instance, due to the amount of loss functions available, one loss function may be better suited for training a machine learning model (e.g., to provide optimal machine learning model performance) based on characteristics of a given training dataset. The system first determines characteristics of a dataset to be used in training the machine learning model to select a loss function from an available set of loss functions. If the training dataset is determined to have a heterogeneous dataset characteristic, the system may select the dynamic loss function for use in training the machine learning model based on the training dataset to improve machine learning model output accuracy and machine learning model performance. Upon determining that the training dataset exhibits the heterogeneous dataset characteristic, the system performs a segmentation process on the received dataset to generate a segmented dataset of the received dataset (e.g., the training dataset). For instance, contrary to the existing systems and methods described above, upon determining that (i) a dataset exhibits a heterogeneous dataset characteristic, and (ii) the dynamic loss function is to be used in machine learning model training, the system generates a segmented dataset to be used in conjunction with training the single machine learning model—thereby reducing utilization of computational resources that would otherwise be wasted when utilizing a multitude of machine learning models to generate outputs based on heterogeneous datasets.

Using the segmented dataset, the system then generates a set of dynamic hyperparameter values. For instance, prior to training the machine learning model (or during a machine learning model training routine), the system may generate the set of dynamic hyperparameter values, where each dynamic hyperparameter value corresponds to (i) a respective data segment of the set of data segments (e.g., of the segmented data set) and (ii) a quantile value. For example, to improve machine learning model performance by reducing underfitting and overfitting for different subsegments of the segmented dataset, each dynamic hyperparameter value may be custom tailored to each data segment. To achieve this unique tailoring, the system generates these dynamic hyperparameter values (e.g., for each sub-segment of the segmented dataset) that is based on a quantile value. For example, the quantile value may be a predetermined quantile value (e.g., a predetermined quantile value of the 95^{th} percentile) or may be dynamic with respect to each data segment (e.g., a first data segment has a 95^{th} percentile quantile value, and a second data segment has a 90^{th} percentile quantile value). That is, contrary to existing systems, such as the Huber Loss function, the system determines a dynamic hyperparameter value based on the data within a given sub-segment of the segmented dataset as opposed to determining a single, predefined, uniform, threshold value (e.g., hyperparameter) with respect to the entire training data distribution of the training dataset. By doing so, rather than using a universally constant hyperparameter, the system uses the custom tailored dynamic hyperparameter values with the dynamic loss function to reduce respective underfitting or overfitting that would otherwise occur when using such single, predefined, uniform, threshold value during machine learning model training.

The system may then train the machine learning model, during a machine learning model training routine, using the dynamic loss function. For example, as discussed above, the system may use the dynamic loss function to train a single machine learning model with the generated set of dynamic hyperparameter values. For instance, as the machine learning model is trained with the dynamic loss function, the system may determine which segment that a feature of the training dataset is associated with (e.g., which segment does a datapoint of the training dataset correspond to, is within, is part of, belongs to, etc.). Upon determining which data segment the feature is associated with, the system may retrieve a dynamic hyperparameter that corresponds to the data segment, and determine a loss (e.g., loss value) using the dynamic loss function that is (i) between a known output value (e.g., a target value, known value, actual value, etc.) and a generated predicted value and (ii) is based on the dynamic hyperparameter value. Using this custom-tailored loss, the system may update one or more parameters of the machine learning model, thereby increasing machine learning model prediction performance and reducing underfitting and overfitting across subsegments of the training dataset. As yet another technical benefit, by using the dynamic loss function with the generated dynamic hyperparameter values, the system allows a single machine learning model to achieve better forecast performance at a more granular level.

Lastly, to ensure optimal machine learning model performance is obtained, the system may retrain the machine learning model based on a determined performance metric. For example, the system may determine a performance metric based on results of the machine learning model training routine. For instance, the performance metric may be a quantitative or qualitative metric that measures a level of performance of the machine learning model. When the performance metric fails to satisfy a threshold performance metric value, the system may re-generate the set of dynamic hyperparameter values using an updated quantile value prior to retraining the machine learning model. Upon re-generating the dynamic hyperparameter values, the system may retrain the machine learning model. By doing so improves the overall machine learning model output performance by adjusting the custom-tailored, dynamic, hyperparameter values that are keyed toward respective segments of a segmented training dataset.

In some aspects, methods and systems for improving machine learning model performance when training machine learning models on heterogeneous datasets via dynamic loss functions are described. For example, the system may receive, during a machine learning model training routine, a dataset for training a machine learning model. The system may determine whether the received dataset exhibits a heterogeneous characteristic. In response to determining that the received dataset exhibits the heterogenous characteristic, the system selects a dynamic loss function, wherein the dynamic loss function is associated with heterogeneous dataset process and comprises a dynamic hyperparameter that changes with respect to each segment of a segmented dataset distribution. The system may then perform a segmentation process on the received dataset to generate a segmented dataset of the received dataset comprising a set of data segments, wherein each data segment corresponds to a sub-dataset of the received dataset. The system then generates a set of dynamic hyperparameter values, based on each data segment of the set of data segments, wherein each dynamic hyperparameter value of the set of dynamic hyperparameter values corresponds to a respective data segment of the set of data segments and a quantile value. The system provides the received dataset to the machine learning model, during the machine learning model training routine, to train the machine learning model using the dynamic loss function, wherein the dynamic loss function is based on the set of dynamic hyperparameter values. The system then determines a performance metric based on results of the machine learning model training routine, wherein the performance metric is related to the quantile value. In response to the performance metric failing to satisfy a threshold performance metric value, the system re-generates the set of dynamic hyperparameter values using an updated quantile value prior to retraining the machine learning model with the dynamic loss function.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

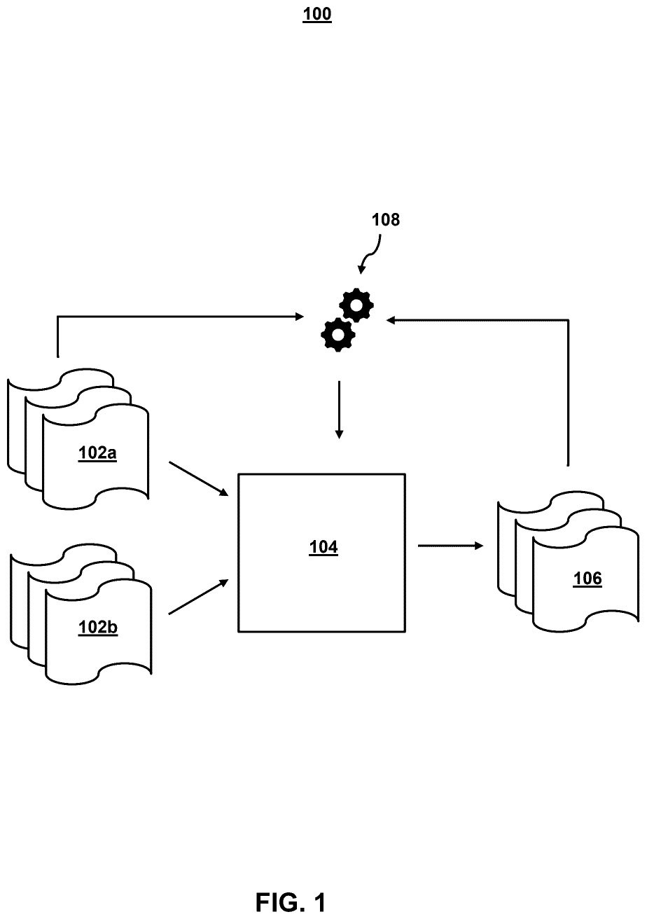

FIG. 1 shows an illustrative diagram for training a secured model using a dynamic loss function, in accordance with one or more embodiments.

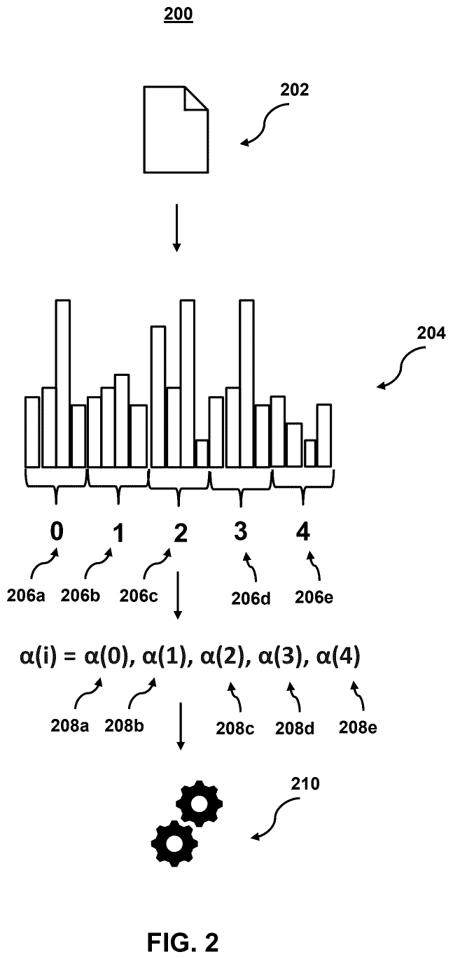

FIG. 2 shows an illustrative diagram for determining the dynamic hyperparameter value for the dynamic loss function, in accordance with one or more embodiments.

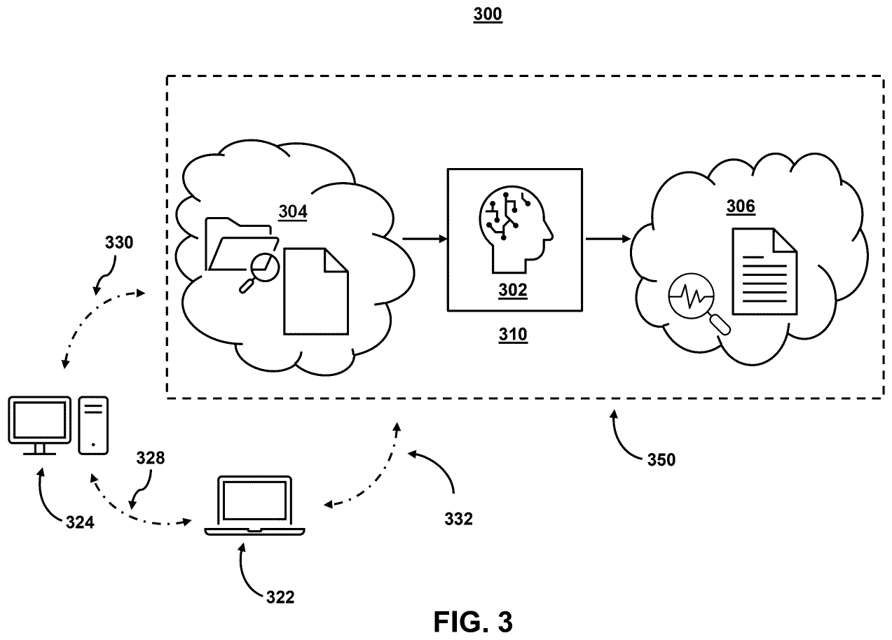

FIG. 3 shows illustrative components for a system used to train a secured model, in accordance with one or more embodiments.

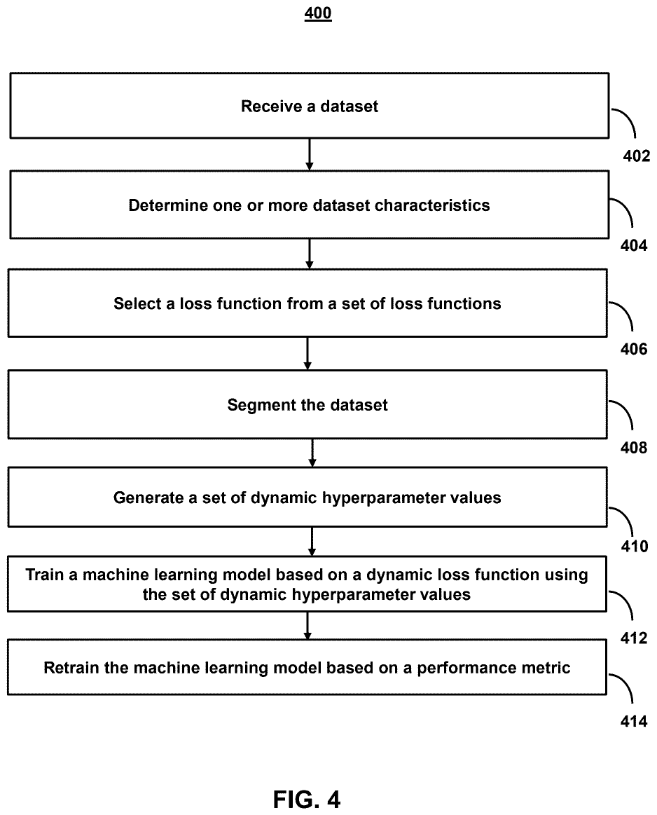

FIG. 4 shows a flowchart of the steps involved in improving the performance of a secured model trained with heterogeneous data via a dynamic loss function, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

FIG. 1 shows an illustrative diagram of a training system 100 for training a secured model using a dynamic loss function. For instance, the secured model may be a machine learning model. The machine learning model may be secured in a secured computing environment that is protected via one or more firewalls, antivirus software, encryption protocols, intrusion detection and prevention systems, authentication mechanisms, or the like. By doing so, the system may provide a secure environment for training secured machine learning models-thereby mitigating the risk of malicious obtainment of proprietary data. For example, FIG. 1 illustrates a machine learning model 104 receiving training data 102a-102b comprising a set of expected values 102a and a set of input features 102b which are used to generate a set of predicted values 106. The machine learning model 104, or model 104, may then use a dynamic loss function 108 to compare the set of expected values 102a to the set of predicted values 106 to update the configurations of the machine learning model 104 (e.g., weights, biases, etc.). The dynamic loss function 108 allows for better forecasting of future datasets that display a heterogeneous characteristic, by updating the configurations of the machine learning model 104.

The machine learning model 104 may be designed to complete a specific task. This task may be to generate the set of predicted values 106 representing future values of datasets, missing values in the dataset, classifications of the values of the dataset into different categories or identify patterns in the dataset. To accomplish the task, a machine learning model 104 may go through a series of steps to ensure the task is done accurately. These steps may include training, validation, testing, deployment, and in some cases, retraining.

As previously stated, FIG. 1 shows a training system 100 for training the machine learning model 104. Training a machine learning model 104 may allow the machine learning model 104 to learn from training data to accurately complete the task it was designed for by updating the configurations of the machine learning model 104. The configurations of a machine learning model 104 depend on the type of the machine learning model 104 being deployed. For example, a neural network may apply weights and biases to each neuron within the model to optimize the predictions of the model. While a linear model may apply weights that multiply the input features to influence the predictions of the model.

To begin training the machine learning model 104, the machine learning model 104 may receive training data 102 including a set of expected values 102a and a set of input features 102b. The training data may be inputted by a user, retrieved from a database, inputted directly from one or more sensors collecting the data, or form another data source. The set of expected values 102a and the set of input features 102b may comprise data from multiple sources and may comprise different data types. For example, the set of input features 102b may comprise a dataset of numerical data from a series of sensors as well as categorical data from a secondary dataset, while the expected values were generated by a user. In some embodiments, an expected value of the set of expected values 102a may be associated with one or more input features of the set of input features 102b and a predicted value of the set of predicted values 106. For example, during machine learning model 104 training, a known value that should be outputted via the machine learning model 104, based on a set of input features, may be compared to a generated output of the machine learning model 104. Based on such comparison, one or more configurations (e.g., weights, biases, or other parameters) of machine learning model 104 may be updated.

In some embodiments, the training data (e.g., used to train the machine learning model) may be an encrypted dataset to protect the underlying data. For instance, in some embodiments, the system may process encrypted data using homomorphic encryption. Homomorphic encryption allows for the processing of encrypted data without decrypting the data prior to providing the encrypted data to a given component. For instance, by leveraging homomorphic encryption, the system may determine whether the encrypted dataset exhibits heterogeneous dataset characteristics, segment the encrypted dataset, train the secured model on the encrypted dataset, determine one or more performance metrics of the secured model based on the encrypted dataset, or other operations consistent with one or more embodiments. Such operations may be performed using the encrypted data, where, upon a final processing of the encrypted data, the associated results may be decrypted and used in other applications. By doing so, the system may provide a secured machine learning model training routine using encrypted data to protect the confidentiality of the underlying training data and model. However, in some embodiments, the system may encrypt the data between the one or more operations and decrypt the data upon processing. For example, the system may first decrypt the training data prior to determining heterogeneous dataset characteristics to be processed by one or more components described herein, and then reencrypt the training data prior to passing (e.g., sending, transmitting, etc.) the training data to another component (e.g., to segment the training data set). By doing so, the system maintains confidentiality of the training data while reducing the computational burdens of homomorphic encryption.

The machine learning model 104 may first analyze the set of input features 102b and generate the set of predicted values 106. The set of predicted values 106 may be regression predictions, classification predictions, multiclassification predictions, or another prediction type. For example, if the predicted value type is a regression output, the machine learning model 104 may predict how much an owner of a credit card may spend in the next month based on the spending of the owner in previous months. If the predicted output type is a classification prediction, the machine learning model 104 may label a credit card transaction as fraudulent or not fraudulent. Or if the predicted output type is a multiclassification prediction the predicted value 106 may be a probability that an input is each class. For example, if the input is an image, the predicted output may be the probability that the image is a dog, a cat, or a fish.

The machine learning model 104 may then use a loss function to compare the set of expected values 102a and the set of predicted values 106. The set of expected values 102a comprise a dataset of what is expected to be outputted by the machine learning model 104 based on the set of input features 102b. The set of expected values 102a may be generated by a person or a previous machine learning model. For example, if the machine learning model 104 is a classification model, the set of expected values 102a may be the correct classification for the machine learning model to make for each of the set of input features 102b. In other models, the set of expected values 102a may be based on historical data and may detail the values of the target variable the model is trying to predict.

A loss function may be selected based on the characteristics of the set of input features 102b and the task the machine learning model 104 is being trained to perform. For example, if the set of input features demonstrate a heterogeneous characteristic, the loss function may be the dynamic loss function 108. The dynamic loss function 108 may handle the heterogeneous characteristic by being sensitive to varying segment-level outliers. This sensitivity may be accomplished by the dynamic loss function 108 including dynamic hyperparameter values that vary between sub-segments of the set of input features 102b.

The dynamic loss function 108 may be used to compare the set of predicted values 106 to the set of expected values 102a each time one of the predicted values of set of predicted values 106 is generated by the machine learning model 104 throughout the training process. Upon comparing a predicted value of the set of predicted values 106 to the set of expected values 102a, an optimization process may be utilized to take the comparison and adjust the configurations (e.g., parameters, such as weights and biases) of the machine learning model. Adjusting the configurations may minimize the dynamic loss function's calculated error, thus improving the model's performance. For example, during a subsequent iteration of the machine learning model being provided the same input data, the machine learning model may generate an updated set of predicted values 106 which is then compared to the set of expected values 102a (which may further correspond to a subset of the set of input features 102b). Due to the dynamic loss functions prior adjustment of the configurations of the machine learning model, a loss value calculated by the dynamic loss function in its prior iteration is updated to a new loss value. Such a process may be performed iteratively until the loss value is minimized to satisfy a threshold loss value (e.g., user provided, predetermined, etc.). Each iteration may cause the adjustment of the parameters of the machine learning model, thereby causing the overall performance of the machine learning model to improve. As another example, the optimization process may include calculating a gradient based on the results of the loss function, which is then used to update the configurations of the machine learning model.

The machine learning model 104 may then be retrained if a performance metric of the machine learning model fails to satisfy a threshold performance metric. For example, as will be explained later, in response to a performance metric resulting from training the machine learning model fails to satisfy a threshold performance metric, the system may retrain the machine learning model based on a set of updated dynamic hyperparameter values via the dynamic loss function 108.

The system may be used to improve machine learning model performance. As used herein, a machine learning model performance is an indicator of how well a machine learning model completes the task it was trained to perform. For example, if a machine learning model is trained to classify a fruit based on an image, the performance would be how well the model is able to classify a picture of an orange as an “orange” and how well the model can classify a picture of an apple as an “apple”. For the performance of a machine learning model to be improved, a performance metric of the machine learning model may be determined. The performance metrics used for a particular machine learning model vary depending on the task it has been trained to perform. In classification models, the performance metric may be a metric that measures accuracy, precision, or recall sensitivity. While in regression problems, the performance metric may measure mean absolute error, mean squared error, or root mean squared error. For example, for the fruit identifying model to show improved performance, it would have to correctly identify a picture of a watermelon as a “watermelon” a higher percent of the time than the model had previously.

To improve the performance of a machine learning model, a loss function may be used during the training process. The loss function may compare the machine learning model's predicted value and the expected value, to then modify the configurations of the machine learning model, such as weights and biases. Modifying the weight and balances of the machine learning model may impact the performance of the machine learning model. However, for the loss function to accurately modify the configurations of the machine learning model, a proper loss function for the input features may be used. For example, if the input features of a machine learning model display distinct heterogeneous characteristics across different sub-segments of the data, a loss function, such as the dynamic loss function 108 of FIG. 1, is capable of adequately addressing the unique characteristics of the data. In some embodiments, the loss function may itself be the performance metric used to measure the performance of the machine learning model.

In some embodiments, the performance of a machine learning model may be improved by modifying the dataset being inputted into the machine learning model. These modifications may include collecting more data or cleaning the data. Collecting more data allows the machine learning model to have more data to learn from, which may improve the performance. While cleaning the data may involve filtering out any noise that may be overlaid on the data. However, collecting more data may not always be possible depending on the source of the data, and cleaning the data may result in worse performance if there is an unknown relationship between some of the data that may be interpreted as noise, damaging the ability of the machine learning model to develop an understanding of the relationships between the data.

In other embodiments, a single machine learning model may be replaced by multiple machine learning models. This is one way to address datasets with distinct heterogeneous characteristics across sub-segments of the data. A single machine learning model may be trained to accurately generate the predicted value for each sub-segment. However, this process of using a machine learning model for each sub-segment may lose some patterns between the sub-segments of data and may also slow down the time it takes to predict the outcome of a dataset.

In yet another embodiment, the performance of the machine learning model may be improved by modifying the loss function. For example, if using the dynamic loss function, the data segments may be modified such that each segment captures different data, or the number of segments may be modified. The hyperparameters of the dynamic loss function may also be modified.

FIG. 2 shows an illustrative diagram for determining the dynamic hyperparameter value for the dynamic loss function, in accordance with one or more embodiments. For example, diagram 200 shows a dataset 202, a segmented dataset 204, data segments 206a-206e, dynamic hyperparameter values 208a-208e, and dynamic loss function 210. As stated above, a loss function may be selected based on the characteristics of the received dataset. In scenarios where the received dataset is associated with a heterogeneous characteristic, the dynamic loss function 108 may be utilized to train the machine learning model 104 due to the dynamic loss function 108 including dynamic hyperparameter values that vary across segments of the received dataset. Diagram 200 shows an illustrative process of determining the hyperparameter values for each segment of the received dataset.

Diagram 200 begins with receiving a dataset 202. For example, the dataset 202 may be any dataset for use in training a machine learning model. In some embodiments, the dataset 202 may exhibit a heterogeneous characteristic. How the dataset 202 is determined to have the heterogeneous characteristic is described further in the description of FIG. 4.

Diagram 200 then shows a segmentation process on the set of input features of dataset 202. For example, where the dataset 202 corresponds to training data 102, the input features 102b of the training data 102 may be segmented into data segments 206a-206e to form segmented dataset 204. In some embodiments, the data segments 206a-206e may be of equal width or may be of unequal width with respect to each other data segment of the data segments 206a-206e. For example, the width may be associated with a number of input features of dataset 202 has, a number of data points within a given data segment of the data segments 206a-206e, a size (e.g., amount of computer memory used to store data of a given data segment) of a given data segment of the data segments, or other metric for determining or otherwise measuring the width of a data segment. The data segments 206a-206e may be generated based on each data segment displaying distinct distributions of data, based on the outliers within each segment, randomly selected, based on preset intervals, or other characteristics of the dataset.

Diagram 200 then shows hyperparameter values. For example, each data segment 206a-206e may be associated with a respective dynamic hyperparameter value 208a-208e. The hyperparameter values 208a-208e may be values that correspond to data segment 206a-208e. For example, first dynamic hyperparameter value 208a may correspond to first data segment 206a, second dynamic hyperparameter value 208b may correspond to second data segment 206b, third dynamic hyperparameter value 208c may correspond to third data segment 206c, fourth dynamic hyperparameter value 208d may correspond to fourth data segment 206d, and fifth dynamic hyper parameter value 208e may correspond to fifth data segment 206e. It should be noted, however, that diagram 200 is merely exemplary and less or more data segments 206a-208e, and dynamic hyperparameter values 208a-208e may exist.

In some embodiments the dynamic hyperparameter values 208a-208e of each data segment 206a-206b may be a quantile, percentile, quartile, or another value that is respective to the data included within the corresponding data segment 206a-206b. For example, the dynamic hyperparameter values may be unique to a given index “i”. For example, the equation shown in diagram 200, α(i), indicates a dynamic hyperparameter value of the given index “i”. The index “i” corresponds to a data segment 206a-206e. For instance, when “i” equals one, the hyperparameter value corresponds to the second dynamic hyperparameter value (e.g., α(1)), which indicates the dynamic hyperparameter value that corresponds to the second data segment 206b. By generating dynamic hyper parameter values 208a-208e such that they respectively correspond to data segments 206a-206e, the system may improve machine learning model performance (e.g., by reducing model overfitting and underfitting) by retrieving the dynamic hyperparameter value that corresponds to an input feature of a given data segment 206a-206e during a machine learning model training routine. That is, as opposed to existing systems that leverage a generalized hyperparameter threshold value, the dynamic hyperparameter values are uniquely keyed to respective data segments 206a-206e. This creates a unique threshold value for each data segment 206a-206e to mitigate the impact of outlier values within the given data segment, while preserving nuanced patterns within the dataset 202. By doing so, machine learning model performance may be increased as varying outlier values inherent within the dataset at the segment-level are accounted for without losing valuable data by generically applying a threshold value to filter out outliers across the entire dataset.

The system may determine whether a dataset exhibits heterogeneous characteristics. In disclosed embodiments, a heterogeneous characteristic may indicate that the data within the/a dataset (e.g., training dataset for training a machine learning model) is diverse and varied. In some embodiments, the source of the heterogeneous characteristic may arise from an unobserved variable or be related to observed variables in some manner unknown to the modelers training the machine learning model. In some embodiments the heterogeneous characteristics may be exhibited by the training dataset containing different types of data such as numerical, categorical, textual, or images or may be exhibited by a training dataset with data coming from varying data sources, resulting in variations in the data structure. For example, the training dataset may include user profiles which contain information such as demographic information and behavioral data, the training dataset could also contain transaction data related to transactions of many different user profiles. This would result in the training dataset containing different data sources, with each data source providing different types of information, resulting in a heterogenous characteristic of the training dataset. In other embodiments, the heterogeneous characteristics may be exhibited by differences in the quality of the training dataset, some sections may contain distorted data (e.g., from noise) or there may be a diverse distribution of data points across different segments of the training data. In some embodiments, the diverse distribution of data points may result in distinct outlier values across segments of the data, which impact the machine learning model's ability to determine relationships or other patterns within the data. For example, as previously stated, in training machine models that utilize a “boosting technique”, failing to account for or mitigate the heterogeneous characteristic causes the machine learning model to place more weight on the outlier observations within the training data. This results in the machine learning model learning erroneous relationships or patterns within the data, thus decreasing the overall model performance.

In some embodiments, the system may determine if the training dataset contains a heterogeneous characteristic by observing the training dataset before inputting it to the machine learning model. For example, this may be done by determining the raw training dataset values or by visualizing the training dataset through plots, histograms, or other graphical representation for the above-described characteristics of heterogeneous datasets. Determining if the training dataset contains the heterogeneous characteristic prior to training the machine learning model based on observations/determinations of the training dataset allows for a loss function better suited for handling heterogeneous datasets to be selected during the first iteration of training the machine learning model, which may result in better performance of the model after the first training iteration. Furthermore, the observations of the training dataset may indicate if a segmentation process is needed, which may further affect which loss function is utilized.

In some embodiments, the system may determine if the training dataset contains a heterogeneous characteristic by observing the results of the trained machine learning model. For example, this may be done by comparing the predicted values of the model compared to the expected values or by visualizing the predicted values of the model compared to the expected values through plots, histograms, or other graphical representations. In some embodiments, comparisons of the predicted values versus the expected values may show that the model is over or under forecasting (e.g., overfitting/underfitting) in different segments of the data, which may indicate the training dataset exhibits a heterogeneous characteristic. In some embodiments, a performance metric may indicate that the model's performance varies greatly across different segments of the data, which may indicate that the training dataset displayed a heterogeneous characteristic. Determining if the training dataset contains the heterogeneous characteristic after training the model still allows for a different loss function to be utilized, which will then improve the performance of the model across the different segments.

The system may also select a loss function to be utilized in the machine learning model training process. A loss function may measure how well a model predicts a given output, based on a given input, with respect to an expected output. The loss function may quantify the difference between the model's prediction and the expected values of the training dataset. The loss function, or the loss function's calculated difference, may then be used to modify parameters of the model (e.g., weights, biases, etc.). There are many different loss functions that may be used in the training of a machine learning model, some of which include: quadratic loss functions, log-loss functions, hinge loss functions, mean absolute error functions, Huber loss functions, quantile loss functions, and dynamic loss functions.

In some embodiments, a quadratic loss function may be used. The quadratic loss function may square the difference between the expected value and the predicted value of the machine learning model, which results in outliers contributing significantly more to the loss since outliers may result in a larger difference between the expected value and the predicted value. Therefore, the quadratic loss function may result in poor performance in forecasting data with many outliers.

In some embodiments, the log-loss function may be used in binary or multi-class classification machine learning models, where the output of the model classifies the inputted data as one of two or more classification categories. An example of a binary classification model may be a model that is being trained to classify a shape as either a square or a circle may utilize the log-loss function, while a multi-class classification model may classify the shape as a square, circle, or triangle. Each output of the log-loss function is a number between zero and one, indicating the predicted probability of the inputted data falling into each of the classes. Continuing with the previous example, in the binary classification model, a zero may indicate a prediction of a square while a one indicates a prediction of a circle. In the multi-class classification model, the output of the log-loss function is a predicted possibility for each class. Again, continuing with the previous example, in the multi-class classification model, the prediction may include three values, indicating the confidence of the input being a circle, square, and triangle. However, the log-loss function is not a viable loss function to use in machine learning models designed for completing tasks outside of classification, such as regression or unsupervised learning. Furthermore, log-loss functions penalize predictions of the model that are of a high probability, but do not match the expected value, which can lead to inaccurate predictions of outliers or less common values, causing poor performance in forecasting data with many outliers.

In some embodiments, the hinge loss function may be used for classification models based on finding a decision boundary that maximizes the difference between different classes of data points. The hinge loss function may involve calculating the difference between the expected values and the model's predicted value to create a decision boundary, which separates data points belonging to different classifications. This results in the hinge loss function being especially sensitive to outliers since outliers disproportionately influence the location of the decision boundary, potentially leading to poor classification forecasting.

In some embodiments, the mean absolute error function may be used in machine learning models performing regression tasks to determine the average magnitude of errors between the expected value and the predicted value of the model. This may result in the mean absolute error being more robust to outliers than other loss functions. However, due to the calculation being based on the average magnitude, outliers are treated uniformly with all other data points and all errors (e.g., over forecasting and under forecasting) are treated equally, which may not be desired in all machine learning models.

In some embodiments, the Huber loss function modifies the quadratic loss function to place less emphasis on the outlier values. This may be accomplished through the use of a parameter (e.g., a quantile) that defines a pre-specified threshold that controls how much weight may be applied to outliers. For example, when a value is greater than the parameter, less weight may be given to the value to prevent over or under forecasting. However, due to the parameter being universally constant across the entire distribution of the dataset, outliers that vary across segments of the data, as seen in some cases of heterogeneity, may still result in over or under forecasting.

In some embodiments, the log-cosh loss function modifies the mean absolute error function to be more robust to outliers. This is accomplished through taking the logarithm of the hyperbolic cosine of the difference between the expected value and the predicted value of the model, which mitigates the impact of extreme outliers. However, the extreme smoothing resulting from the log-cosh loss function may result in less exact error magnitudes, which may not always be desirable.

In some embodiments, the quantile loss function may be used to predict a specific quantile of the dataset's distribution, where the quantile is specified before utilizing the loss function. However, similar to the mean absolute error function, the quantile loss function relies on the absolute difference of the expected value and the predicted value of the model, which results in the model being more sensitive to outliers, which may result in poor forecasting.

In some embodiments, the dynamic loss function may be used to improve machine learning model performance where the machine learning model is trained on datasets with distinct heterogeneous behavior across distinct sub-segments. To accomplish this, the dynamic loss function may include a dynamic hyperparameter that varies between sub-segments of the dataset. In some embodiments, the dynamic hyperparameter may be a user-selected, or predetermined, quantile based on the distribution of each respective sub-segment. For example, the user may select the dynamic hyperparameter that may be set at the 95^{th} percentile for the first segment, the 80^{th} percentile for the second segment, and the 25^{th} percentile for the third segment.

Additionally or alternatively, the dynamic hyperparameter may be the same value (e.g., 95^{th} percentile) for each segment of the data segments of the dataset. However, the uniqueness of the dynamic hyperparameter is that, even if the dynamic hyperparameter is set to be the same value across all data segments, the resulting dynamic hyperparameter value for each segment is specifically keyed to the data included within a respective data segment. For example, since each data segment of a set of data segments may include different outlier values, the dynamic hyperparameter value for a first data segment may be different from that of the dynamic hyperparameter value of another data segment. That is, since the dynamic hyperparameter value is calculated for a specific data segment (e.g., only relies on the data included within that specific data segment), the threshold for determining what constitutes an outlier within that specific segment can be different from that of another segment. In this way, the system identifies the unique threshold values for each data segment when considering outliers. This in turn enables a dynamic loss function to use the unique threshold values (e.g., dynamic hyperparameter values) during a training routine to provide less weight to outliers that are respective to each segment to more accurately learn meaningful patterns within a dataset without losing valuable data stemming from a generic threshold value applied to each data segment as existing systems have done. As the hyperparameter dynamically varies according to the different sub-segments of the dataset, the system provides improved machine learning model performance as the machine learning model prevents underfitting and overfitting at the data-segment-level.

The system may use a data segmentation process. In disclosed embodiments, a data segmentation process may include breaking up the training dataset into data segments to allow for better forecasting of the machine learning model. These segments (e.g., data segments) can be based on a number of different characteristics of the training dataset. In embodiments where the data has a time component, the segments may be based on different time periods. For example, if looking at the amount of money spent in transactions throughout the year, the data may be broken up into time periods of months, weeks, or even days for better forecasting of the machine learning model. In embodiments where the training dataset displays heterogeneity that is distinct across sub-segments of the dataset, such as distinct outlier values, the data segmentation process may break the dataset up into segments with similar heterogeneity. The data segments could be determined by observing the raw training dataset or by visualizing the training dataset through plots, histograms, or other graphical representation to aid in the observation of the training dataset. For example, when observing the training dataset for the maximum historical balance a customer has in their bank account compared to the change in the balance of the same account, it may be seen that different segments of the maximum historical balance of the customers have different outlier values for the change in balance. Specifically, the customers with a maximum historical balance between zero and ten million dollars may have an outlier change in the balance of ten million dollars while the customers with a maximum historical balance between forty and fifty million dollars may have an outlier change in balance of negative fifty million dollars. Similar differences in outliers may also be seen across groups of customers with a maximum historical balance incrementing by ten million dollars from ten million dollars up to fifty million dollars. These groups of customers have very different outliers, and thus should be broken up into separate segments.

The system may use a performance metric to evaluate the performance of the machine learning model. In disclosed embodiments, the performance metric may be a quantitative or qualitative metric determined based on the results of the machine learning model training routine to indicate how well the model's predicted values match the expected training values. The performance metric may then be used to determine whether to (i) retrain the model or (ii) modify one or more parameters of the machine learning model (e.g., weights, biases, etc.) to ensure optimal machine learning model performance is obtained. In some embodiments, the performance metric is a loss function. In some embodiments, the performance metric is the loss (e.g., loss value) calculated by the/a loss function (e.g., dynamic loss function). In some embodiments, the performance metric is the result of a calculation of the accuracy of the machine learning model. The accuracy may be calculated in the form of mean absolute error (MAE), mean squared error (MSE), root mean squared error (RMSE), or other accuracy calculation.

FIG. 3 shows illustrative components for a system used to train a secured model, in accordance with one or more embodiments. For example, FIG. 3 may show illustrative components for training a machine learning model to accurately forecast outcomes for data exhibiting a heterogeneous characteristic. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include the training dataset, including the set of expected values 102a and the set of input features 102b of FIG. 1, and the set of loss functions, including the dynamic loss function, and the predicted outputs of a machine learning model. Cloud components 310 may access one or more databases storing one or more historical training datasets, predicted values generated by a machine learning model, accuracy threshold values, loss functions, and dynamic hyperparameter values for the dynamic loss function.

Cloud components 310 may include model 302, which may be a machine learning model, artificial intelligence model, etc. (which may be referred collectively as “models” herein). For example, model 302 may correspond to machine learning model 104 (FIG. 1). Model 302 may take inputs 304 (e.g., training data 102a-102b (FIG. 1)) and provide outputs 306 (e.g., the set of predicted values 106 (FIG. 1)). The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., the predicted value of the target variable).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., a financial balance change, an end-of-day balance, a beginning-of-day balance, monthly balance change, weekly balance change, etc.).

In some embodiments, the model (e.g., model 302) may automatically perform actions based on outputs 306. In some embodiments, the model (e.g., model 302) may not perform any actions. The output of the model (e.g., model 302) may be used to determine a loss, dynamic loss function, to determine if the configurations of the model (e.g., model 302) are to be modified. The output of the model (e.g., model 302) may also be used to determine if the model (e.g., model 302) needs to be retrained.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

FIG. 4 shows a flowchart of the steps involved in improving the performance of a secured model trained with heterogeneous data, in accordance with one or more embodiments. For example, the system may use process 400 (e.g., as implemented on one or more system components described above) to determine a set of hyperparameter values for a dynamic loss function to improve the performance of the machine learning model.

At step 402, process 400 (e.g., using one or more components described above) may receive a dataset. For example, the system may receive a dataset for training a machine learning model. The received dataset may be received from a user, a database, another device capable of storing the dataset, or directly from the sources of the data within the dataset (e.g., sensors, digital platforms, websites, etc.). For example, the data set may be received during a machine learning model training routine to train the machine learning model. Furthermore, the dataset may comprise multiple sections of data from a variety of sources and of a variety of different data types (e.g., numerical data, categorical data, time-based data, etc.). As an example, the received dataset may include data on the monthly change in deposit balances within each customer's bank account with a bank compared to the maximum balance within each customer's bank account. By doing so, the system may result in a trained machine learning model capable of accurately forecasting the movement of deposits within customer's bank accounts across the different maximum balances.

At step 404, process 400 (e.g., using one or more components described above) may determine one or more dataset characteristics. For example, the system may determine one or more characteristics of the received dataset. The characteristics may include the size of the data set, the dataset type (e.g., structured, unstructured, etc.), a heterogeneous dataset characteristic, a homogeneous dataset characteristic, or other characteristics that may be gathered from the dataset. The system may perform one or more operations on the received dataset to determine the one or more data set characteristics. For example, the system may filter, extract, segment, or otherwise analyze the dataset to determine the one or more dataset characteristics of the dataset. For example, the system may determine that the distribution of monthly change in deposit balances within each customer's bank account varies greatly based on the maximum balance within each bank account, which may lead the system to determine that the received dataset exhibits a heterogeneous characteristic across different sub-segments of the data. By doing so, the system may select a loss function that is better suited for heterogeneous datasets which will result in improved performance of the trained model.

In some embodiments, the dataset characteristic may be a heterogeneous dataset characteristic. For example, the system may determine that the received dataset includes a heterogeneous dataset characteristic based on a comparison of determined outlier values of the received dataset to a threshold outlier value. For example, the system may begin by performing a segmentation process on the received dataset to obtain a set of data segments where each of the data segments within the set of data segments corresponds to a sub-dataset of the received dataset. The data segments may be generated based on the received dataset exhibiting distinct characteristics across different sub-datasets or the data segments may be generated through the use of clustering algorithms (e.g., K-Means Clustering, Hierarchical Clustering, etc.), quantiles, percentiles, or another method of segmenting data. In some embodiments, the data segments within the set of data segments may correspond to equally sized sub-datasets of the received dataset. In other embodiments, the data segments within the set of data segments may correspond to sub-datasets of the received dataset that vary in size. For example, for forecasting the movement of deposits within customers bank accounts, it may be determined that the monthly change in account balance of the customer's accounts varies depending on the maximum account balance. Therefore, segments may correspond to ten-million-dollar segments of the maximum account balance, starting at zero and ending at 50 million, these ten-million-dollar segments may then be used as the segments for determining if the received dataset exhibits the heterogeneous characteristic. For instance, in such a case five data segments may be generated, with the first data segment corresponding to account balances of $0 to $10,000,000, a second data segment corresponding to customers having account balances between $10,000,001 to $20,000,000, . . . , and a fifth data segment corresponding to customers having account balances between $40,000,001 to $50,000,000.

Then, the system may determine for each data segment of the set of data segments, a set of outlier values of a target variable within a respective data segment of the set of data segments. For example, for each data segment, the system determines a set of outlier values that are within the respective data segment. The outlier values may be determined by a statistical method (e.g., z-score, modified z-score, etc.), a machine learning model trained to determine outliers or by an outlier “threshold” which indicates that values greater than the threshold are outliers. The target variable may be a variable associated with an intended output of the machine learning model. For example, the target variable may be one or more features of an input dataset to be analyzed to generate a prediction, a given feature of an input dataset to be analyzed to generate a prediction, a value of an input feature of an input dataset to be analyzed to generate a prediction, a difference between two or more values of an input feature of an input dataset to be analyzed, or other target variable. In some embodiments the target variable may be one or more of the sections of data within the received dataset, or the one or more sections of the data within the received dataset that contain segments exhibiting distinct characteristics. The target variable may be defined by a user or predetermined from a stored target variable indication found within the system or from an external database or device. Continuing with the previous example, the target variable may be the monthly change in balance for a given customer. Due to the monthly change in balances for a given customer varying with respect to each data segment, what constitutes an outlier value for one data segment of the given data segments may vary between the set of data segments.

As such, the system may then determine a threshold outlier value for the data segments to determine whether the dataset (e.g., as a whole) exhibits a heterogeneous dataset characteristic. For example, the system may determine a threshold outlier value of the target variable. The threshold outlier value may be based on the average of each outlier value of the set of outlier values of each data segment of the set of data segments. In some embodiments, the threshold outlier value may be based on the average of each outlier value of the set of outlier values for select data segments of the data segments. In addition, the threshold outlier value may be a modified version of the average of each outlier value of the set of outlier values, for example, the threshold outlier may apply a weight to select outlier values of interest. In other embodiments the threshold outlier value may be determined by a statistical method (e.g., z-score, modified z-score, etc.) or a machine learning model trained to determine outliers. Furthermore, in some embodiments, the threshold outlier value may be defined by a user or predetermined from a stored target variable indication found within the system or from an external database or device. The outlier values may be determined in a method similar to those described for determining the threshold outlier value. For example, a value of a change in monthly balance may be determined to be an outlier if the value is more than plus or minus three standard deviations away from the average change in monthly balance. The threshold outlier value may then be determined by averaging all the outlier values.

Then, the system may compare each outlier value of the set of outlier values for each data segment of the set of data segments to the threshold outlier value. The system may then determine whether the respective outlier value satisfies a threshold value of the threshold outlier value. For example, a first data segment of the set of data segments may include a set of outlier values having values of $100, $500, and $600. Where it is determined that the threshold outlier value (e.g., for the data set as a whole) is $200, the system may compare each outlier value of the first data segment (e.g., $100, $500, and $600) to the threshold outlier value (e.g., $200). The system may determine whether each outlier value of the first data segment is outside a threshold range of the threshold outlier value. For instance, the threshold range may be a predetermined threshold range, or a user provided range. Additionally, the threshold range may be an absolute value of the range. Continuing with the example, where the threshold range is the absolute value of $100, the system may compare the second outlier for the first data segment (e.g., $500) to the threshold outlier value (e.g., $200). Because the second outlier of the first data segment is outside of the threshold range, the system may determine that the dataset exhibits a heterogeneous dataset characteristic. In this way, the system may determine whether the dataset exhibits heterogeneity at the data-segment level when compared to an average of outlier values of each data segment of the set of data segments.

In some embodiments, the dataset characteristic may be determined to be a heterogeneous dataset characteristic by comparing an average outlier value of each segment of the received dataset to a threshold outlier value. For example, similar to the previous embodiment, the system may perform the segmentation process on the dataset to obtain the set of data segments. With each data segment of the set of data segments corresponding to a sub-dataset of the received dataset. Then for each data segment of the set of data segments, the system may determine a set of outlier values of the target variable within a respective data segment of the set of data segments.

Then the system may generate an average outlier value for each data segment of the set of data segments. For example, the average outlier value may be based on the set of outlier values of the target variable with the respective data segment of the set of data segments. The system may then compare the generated average outlier value of each data segment of the set of data segments to a threshold outlier value. In some embodiments the threshold outlier value may be a user-defined value, may be a predetermined value stored within the system or an external database the system has access to, or determined by a machine learning model.

If the system determines that at least one average outlier value of the data segment of the set of data segments satisfies the threshold outlier value, the system may determine that the received dataset comprises the heterogeneous dataset characteristic. In some embodiments, satisfying the threshold outlier value may occur when at least one average outlier value is greater than or equal to the threshold outlier value or when at least one average outlier value is less than the threshold outlier value. In other embodiments, satisfying the threshold outlier value may occur when at least one average outlier value is within a certain distance from the threshold outlier value. While, in other embodiments, satisfying the threshold outlier value may occur when at least one average outlier value is outside a certain distance from the threshold value. For example, for customer accounts with a maximum balance between zero and ten million dollars (e.g., a first data segment), the average outlier value among the set of customers within that data segment may be determined to have an average monthly balance change of two million dollars. Customer accounts with a maximum balance between $10,000,001-$20,000,000 (e.g., the second data segment) may have an average monthly balance change of eight million dollars Where the threshold outlier value is predetermined to be 5 million dollars, the first data segment may fail to satisfy the threshold outlier value because the first data segment's average monthly balance change was less than the threshold outlier value (e.g., 5 million dollars). However, the second data segment satisfies the threshold outlier value because the second data segment's average monthly balance change is greater than the threshold outlier value (e.g., 5 million dollars). As such, because at least one data segment of the set of data segment's average outlier value satisfies the threshold outlier value, the system determines that the dataset comprises a heterogeneous dataset characteristic. Additionally, as shown in the example above, as compared to existing systems that merely filter out outlier values (whether averaged or individually), as will be discussed below, the system preserves such information to improve a machine learning model's performance by leveraging the dynamic loss function.

In some embodiments, the dataset characteristic may be determined to be a heterogeneous dataset characteristic by comparing the difference between the average target variable of two segments of the received dataset. For example, similar to the previous two embodiments, the system may perform the segmentation process on the dataset to obtain the set of data segments. With each data segment of the set of data segments corresponding to a sub-dataset of the received dataset. The system may then determine an average target variable value for each data segment of the set of data segments. The average target variable value may be the average of target variable values with the respective data segments of the set of data segments. In some embodiments the average target variable value may be the average of the target variable values within each data segment. In other embodiments, the average target variable may be the median, mode, geometric mean, trimmed mean, or other mathematical formula for summarizing the data of the target variable within each segment.

The system may then compute a difference between a first average target variable value of a first data segment of the set of data segments and a second average target variable value of a second data segment of the set of data segments. In some embodiments, the first data segment and the second data segment may be adjacent to one another, in other embodiments, there may be one or more data segments between the first data segment and the second data segment. The process of computing the difference between the first data segment of the set of data segments and the second average target variable value of a second data segment of the set of data segments may then be repeated until all the segments have been compared at least once. In some embodiments the process of computing the difference may be repeated until the difference between each segment within the set of data segments from all the segments within the set of data segments has been computed.

The computed differences may then be compared to a threshold value. In embodiments where the difference fails to satisfy the threshold value, the system may determine that the received dataset comprises the heterogeneous characteristic. The threshold value may be a user-defined value or may be a predetermined value stored within the system or an external database the system has access to. For example, for customer accounts with a maximum balance between zero and ten million dollars, the average outlier value may be determined to be a balance change of eight million and dollars, while customer accounts with a maximum balance between ten million dollars and twenty million dollars the average outlier value may be determined to be a balance change of eighteen million dollars. Therefore, when comparing the average outlier value for the zero-to-ten-million-dollar group and the ten million to twenty million dollar group the difference may be determined to be ten million dollars, which may be greater than the threshold value of five million dollars. The dataset may then be determined to exhibit a heterogeneous characteristic.

In some embodiments, the dataset characteristic may be determined to be a heterogeneous dataset characteristic by comparing the distributions of the different segments of the received dataset. For example, similar to the previous three embodiments, the system may perform the segmentation process on the dataset to obtain the set of data segments. With each data segment of the set of data segments corresponding to a sub-dataset of the received dataset. The system may then determine a probability distribution type corresponding to the data segment of the set of data segments for each data segment of the set of data segments. In some embodiments, the probability distribution type may be a classification of a specific distribution type such as a discrete probability distribution (e.g., Bernoulli distribution, binomial distribution, etc.), a continuous probability distribution (e.g., Gaussian distribution, exponential distribution, etc.), or another distribution classification. In other embodiments, the probability distribution may indicate that one or more characteristics of each segment of the set of data segments such as the shape of the distribution (e.g., skewness, kurtosis, etc.), the range, variance, standard deviation, mean, median, mode, the nature of the data (e.g., discrete, or continuous), or other characteristics.

The system may then compare a first probability distribution type corresponding to a first data segment of the set of data segments to a second probability distribution type corresponding to a second data segment of the set of data segments. If the system determines the first probability distribution type is different from the second probability distribution type, the system may determine that the received dataset comprises the heterogeneous dataset characteristic. For example, for customer accounts with a maximum balance between zero and ten million dollars the probability distribution type of the maximum account balance and the change in the account balance may be determined to be linear, while the accounts with a maximum balance between forty to fifty million dollars, the probability distribution may be determined to be exponential. Therefore, this dataset may be determined to exhibit a heterogeneous characteristic.

At step 406, process 400 (e.g., using one or more components described above) may select a loss function from a set of loss functions. For example, in response to determining that the received dataset comprises the heterogenous characteristic, the system may select a dynamic loss function from a set of loss function. The dynamic loss function may be associated with heterogeneous dataset processing and may comprise dynamic hyperparameter(s) that is based on segments of a segmented dataset distribution. For example, the dynamic hyperparameter may change with respect to each segment of a segmented dataset distribution. In some embodiments, the dynamic hyperparameter may be the mean, variance, or other mathematical measurement of the sub-dataset within each segment of the segmented dataset. In other embodiments the dynamic hyperparameter may be a quantile, percentile, quartile, or another value.

For example, the selected dynamic loss function may be designed to accurately determine a loss value (e.g., a loss) between an expected output and a predicted output of the machine learning model. The dynamic loss function, however, is sensitive to each data segment of the set of data segments. For example, as opposed to existing systems that apply a generic threshold value to a dataset to give less weight to outliers that exist within the dataset as a whole, the dynamic loss function uses dynamic hyperparameter values that are each keyed to a specific segment of the dataset. That is, because existing systems apply such generic thresholds, they cannot accurately account for heterogeneous datasets. For instance, as explained above, what constitutes an outlier value for one data segment of a given dataset may differ for another data segment. If a generic threshold value is applied across the heterogeneous dataset to filter out the values that exceed such generic threshold value, the machine learning model may be trained in such a way that one data segment is underfit, and another data segment is overfit-thereby causing poor machine learning model performance. On the contrary, the dynamic loss function (as well as the dynamic hyperparameter values) leverage a dynamic threshold value that changes with respect to each dataset. By doing so, the machine learning model may prevent underfitting across data segments that are associated with differing outlier values, thereby improving machine learning model performance.

In some embodiments, the dynamic loss function may be determined from a predetermined set of loss functions. For example, the system may select the loss function from a set of loss functions that comprise the dynamic loss function, a quadratic loss function, a log-loss function, a hinge loss function, mean absolute error function, a Huber loss function, a log-cosh loss function, and a quantile loss function. By doing so, the system may select the loss function best suited for training the machine learning model on the received dataset. In the case of the received dataset displaying a heterogeneous characteristic, the system may select the dynamic loss function.

At step 408, process 400 (e.g., using one or more components described above) may segment the dataset. For example, the system may perform a segmentation process on the received dataset to generate a segmented dataset of the received dataset comprising a set of data segments, wherein each data segment corresponds to a sub-dataset of the received dataset. The system may segment the dataset as described above. By doing so, the system may use the segmented dataset to generate a set of dynamic hyperparameter values.

In some embodiments, during the segmentation process, the system may generate one or more labels to the dataset. For example, during the segmentation process (or after the segmentation process), the system may label each data point that is part of the segmented dataset with a segment identifier. For instance, where the dataset includes account balances of a set of customers, the dataset may be segmented into segments that correspond to a range of account balances. For example, the dataset may be segmented into five data segments, where the first data segment corresponds to account balances of $0 to $10,000,000, a second data segment corresponds to customers having account balances between $10,000,001 to $20,000,000, . . . , and a fifth data segment corresponds to customers having account balances between $40,000,001 to $50,000,000. Each datapoint of the dataset may indicate an account balance of a given customer. In some embodiments, prior to segmenting the dataset, the dataset may be featured using one or more featurization techniques, where each data point represents a feature vector comprising one or more labels. For example, a data point of the dataset may be transformed into a feature vector, where the feature vector includes a label indicating an account balance of a customer, a customer identifier, a timestamp, or other information. The system may store such feature vectors for all data points of the dataset in a database. In the context of training a machine learning model, the feature vector may additionally include an expected output label (e.g., an expected value) that indicates an expected output that should be generated based on the account balance of the customer, customer identifier, timestamp, etc.

During (or after) the dataset is segmented, the system may generate a new label indicating which data segment the data point (or feature vector) belongs to. The system may then associate (e.g., add) such labels to the feature vector and store the updated feature vector in a database for later retrieval. For example, the system may determine which data segment a customer belongs to and may add a label to the customer's feature vector indicating a value reflecting which data segment the customer has been segmented into. For example, a first customer having an account balance of $5,0000 may be segmented into the first data segment. As such, the system may generate a label indicating the first data segment. For example, the label may be a numeric value (e.g., 0, 1, 2, etc.), an alphanumeric value (e.g., data_seg_1), a character string (e.g., segment one), or other value. By doing so, as will be explained later, the system may determine which dynamic hyperparameter to use when such input feature vector (e.g., data point) is provided as input to the machine learning model to generate a prediction.

At step 410, process 400 (e.g., using one or more components described above) may generate a set of dynamic hyperparameter values. For example, the system may generate the set of dynamic hyperparameter values based on each data segment of the set of data segments of the received data set, where each data segment corresponds to a sub-dataset of the received dataset. Upon generating the set of dynamic hyperparameter values, the system may store the set of dynamic hyperparameter values in a database, with a label indicating which data segment the dynamic hyperparameter values correspond to. By allowing the dynamic hyperparameter values to vary with the segments of the set of data segments of the received dataset allow the system to properly apply the dynamic loss function throughout the training process. Doing so preserves the integrity of the training data and enables the machine learning model to learn meaningful patterns and relationships at the segment-level of the training data, thereby improving overall machine learning model performance.

In some embodiments, the dynamic hyperparameter value may be based on quantile value. For example, existing systems may currently set a hyperparameter value to the 80^{th} quantile, meaning that any target variable values that are over 80% of the largest target variable value within the dataset is considered an outlier value. Intuitively this makes sense because, in the context of training machine learning models, outliers may skew predictions generated by the machine learning model and can impact machine learning model performance. However, in the case of heterogeneous datasets, what constitutes an outlier value in one segment of the dataset may be vastly different than in another segment of the data segment. If the hyperparameter value was globally set to the 80^{th} quantile and applied to a dataset during machine learning model training, a data segment may be underfit while the model may be overfit to another data segment.

To overcome this, the dynamic loss function may use dynamic hyperparameter values that are based on the data segments themselves. In some embodiments, the quantile value may be the same for each data segment of a segmented dataset. However, not to be confused with existing systems, by using the same quantile value for each data segment, the dynamic hyperparameter values may nonetheless be different as they are based on each respective data segment. For instance, where a first data segment of the segmented dataset involves customers with balances between $0 than $10,000, the 95^{th} percentile of the balance change (e.g., target variable) for these customers may be $500 (e.g., dynamic hyperparameter value of the first data segment). However, a second data segment of the segmented dataset may involve customers with balances between $40,001 to $50,000, and the 95^{th} percentile of the balance change (e.g., target variable) for these customers may be $4,000 (second hyperparameter value of the second data segment). In this example, the dynamic hyperparameter values differ although the quantile value is the same across them. If existing systems were used here (e.g., and used the 95^{th} percentile of the entire data segment), the hyperparameter value would be $800 and may be too large or too small for determining what a given outlier is with respect to the data segments. As such, if existing systems trained the machine learning model using the $800 hyperparameter value (not dynamic), then the resulting machine learning model would be overfit to outliers in the first data segment, and underfit to the outliers in the second data segment. As such, this would cause poor machine learning model performance.

To overcome this, however, the methods and systems disclosed herein allow the dynamic hyperparameter to be informed by the distribution of each data segment of the set of data segments of the received dataset. By doing so, the dynamic loss function causes better performance of the trained model. For example, continuing with the example above, target variable values within the first data segment that are above $500 would be treated as outliers and target variable values within the second data segment that are above $4000 would be treated as outliers (e.g., as opposed to any value within the dataset being above $800 being considered an outlier value). As such, when the dynamic loss function uses the dynamic hyperparameter values, the system may accurately afford less weight to data-segment-level-observed outliers to improve machine learning model performance.

In some embodiments, the quantile value may be a user-selected value, while in other embodiments the quantile value may be predetermined from a stored variable found within the system or from an external database or device. By allowing the quantile to be a user-selected value, the system may have to allow a subject-matter expert to provide control over the output causing more accurate predictions to be generated. This may further then allow the system to train a wider range of models for different tasks. Allowing the dynamic hyperparameter value to be a predetermined value may allow the system to train the machine learning model quicker since the model will not need to wait for a user to select a dynamic hyperparameter type.

In some embodiments, the system may generate the set of dynamic hyperparameter values based on a selected target variable value. For example, the system may select a first data segment of the set of data segments of the received dataset. Then, the system may extract target variable values from the first data segment of the set of data segments. For example, the system may extract monthly balance changes for each customer within a first data segment, where the set of monthly balance changes are for customers who have a balance between 0 and $10,000. The system may then determine a number of target variable values from the first data segment of the set of data segments from the received dataset and may generate an N value by multiplying the number of target variable values from the first data segment to the quantile value. In some embodiments, the number of target variable values from the first data segment may be all the values within the first data segment or in other embodiments, the number of target variable values from the first data segment may be a user-selected number or based on a predetermined value. As an example, if there are 20 target variable values in the first data segment, and the quantile value is the 95^{th} percentile, then the N value may be determined as N=20(0.95)=19.

After generating the N value, the system may generate a sorted list of the target variable values of the first data segment. The sorted list may list the target variable values in ascending order. After generating the sorted list of the target variable values, the system may select the target variable value, from the sorted list, which corresponds to the N value. For example, if the target variable values for the first data segment comprise $ [80, 84, 87, 90, 112, 177, 178, 188, 200, 234, 321, 355, 390, 390, 398, 400, 431, 432, 500, 636], the value that corresponds to the N value would be 500 (e.g., given that it is the 19^{th} value of the sorted list of target variable values). The selected target variable value may be selected as the first dynamic hyperparameter value for the first data segment of the set of data segments. As such, the target variable value of 636 may be considered an outlier value with respect to the first dataset. In some embodiments, this process of determining the dynamic hyperparameter values may be used to determine the dynamic hyperparameter values of the remaining data segments of the set of data segments. By doing so, the system may generate unique hyperparameter values to be used during machine learning model training routines that provide more granular, segment-level, outlier-value determinations. In this way, the system may improve machine learning model performance by learning meaningful, nuanced, patterns at the segment-level of the dataset.

In some embodiments, the system may update the dataset with a dynamic hyperparameter label. For example, the system may retrieve, from a database, a feature vector corresponding to each datapoint of the dataset. For example, where the dataset indicates customer balances, each data point may indicate a customer and their respective account balance. The system determines, based on the previously generated data segment label of the customer's feature vector, which data segment the customer belongs to. The system may then associate (e.g., add, update, etc.) a dynamic hyperparameter label to the feature vector and store the updated feature vector in a database for later retrieval. For example, the system may determine which data segment a customer belongs to and may add a label to the customer's feature vector indicating a value reflecting the dynamic hyperparameter value that corresponds to the data segment that the customer belongs to. For example, a first customer having an account balance of $5,0000 may be segmented into the first data segment. As such, the system may generate a label indicating the first dynamic hyperparameter value. For example, the label may be a numeric value (e.g., 0, 1, 2, etc.), an alphanumeric value (e.g., data_seg_1), a character string (e.g., segment one), or other value. By doing so, the system may update such feature vectors to enable the machine learning model to be informed as to which dynamic hyperparameter value should be used during machine learning model training.

At step 412, process 400 (e.g., using one or more components described above) may train the machine learning model based on the dynamic loss function using the set of dynamic hyperparameter values. For example, the system may provide the received dataset to the machine learning model to train the machine learning model using the dynamic loss function. For example, the dynamic loss function may use the set of dynamic hyperparameter values that were generated (e.g., step 410). In some embodiments, the received dataset provided to the machine learning model is the segmented dataset (e.g., as discussed in step 408). By doing so, the machine learning model may be provided with additional information that indicates a data segment to which an input feature (e.g., a target variable value) of the training data set belongs to. In this way, the system may select the dynamic hyperparameter value corresponding to the data segment to which the input feature belongs to, thereby improving machine learning model performance, and preventing the model from overfitting/underfitting with respect to subsegments of the training dataset.

In some embodiments, the machine learning model may be trained during a machine learning model training routine. For example, during a machine learning model training routine, the system may cause the machine learning model to generate a predicted value based on a first data point from a first data segment from the segmented dataset. The predicted value may be a classification label, a predicted numerical value, or other output of the machine learning model based on a feature vector (e.g., a first data point) from the first data segment from the segmented dataset. For example, where the first data segment of the segmented dataset includes data points (e.g., target variables, in the form of an input feature) that indicate customers with balances between $0 than $10,000, the system may generate a predicted value (e.g., a balance change of a given customer) based on a first customer who has a current balance of $600.

The system may then determine a first dynamic hyperparameter value of the set of dynamic hyperparameter values that corresponds to the first data segment. For example, where an input feature vector corresponding to a customer includes a dynamic hyperparameter label, the system may retrieve the dynamic hyperparameter value from the input feature vector. As another example, due to the segmentation process of the data set segmenting the data, the system may determine a first dynamic hyperparameter value of the set of dynamic hyperparameter values that corresponds to the first data segment. For example, the system may retrieve from a database storing the set of dynamic hyperparameter values for the segmented dataset, the dynamic hyperparameter value that corresponds to the first data segment. For example, the system may determine which data segment the customer is part of and retrieve the corresponding dynamic hyperparameter value from the database to be used in generating a loss value.

The system may then generate a first loss value using the dynamic loss function based on the predicted value and a target value in response to an absolute difference between the predicted value and the target value being less than or equal to the first dynamic hyperparameter value. For example, the system may retrieve, from a feature vector, the target value (e.g., expected output value). The system may then determine a difference between the predicted value and the target value. Using the difference, the system may determine the absolute value of the difference and compare the absolute value of the difference to the first dynamic hyperparameter value. If the absolute value of the difference is less than or equal to the first dynamic hyperparameter value, the system may generate a first loss value in lieu of a second loss value. For example, the first loss value may be one half multiplied by the square of the target value minus the predicted value. Upon generating the first loss value, the system may update one or more parameters (e.g., weights or biases) of the machine learning model based on the first loss value.

In some embodiments, however, the one or more parameters of the machine learning model may be updated based on a second loss value. For example, where the absolute value of the difference is anything by less than or equal to the first dynamic hyperparameter value, the system may generate a second loss value. The second loss value may be the first dynamic hyperparameter value multiplied by a second value, where the second value is the difference between the absolute difference between the target value and the predicted value and one half multiplied by the first dynamic hyperparameter value. In some embodiments, the system may update the one or more parameters of the machine learning model based on the second loss value.

That is, expressed as a formula, the dynamic loss function is:

$${L}_{α} ( y , f ( x ) , i ) = \{ \frac{1}{2} {( y - f ( x ) )}^{2} for \vert y - f ( x ) \vert \leq α ( i ) , α ( i ) ( \vert y - f ( x ) \vert - \frac{1}{2} α ( i ) ) otherwise \}$$

Where L_{α} is a loss value, y is the target value, f(x) is the predicted value, and α(i) is the dynamic hyperparameter value corresponding to a given data segment i.

Therefore:

$$First Loss Value = \frac{1}{2} {( y - f ( x ) )}^{2}$$

$$and$$

$$Second Loss Value = α ( i ) ( \vert y - f ( x ) \vert - \frac{1}{2} α ( i )$$

As shown above, since the dynamic hyperparameter value α(i) is dependent upon which data segment i a respective datapoint of the dataset belongs to, the system provides improved machine learning model performance as the implication of what constitutes an outlier is dependent on the respective data segment. This in turn enables the system to update the machine learning model's parameters based on an optimized error because (i) the threshold value (of what constitutes an outlier) is dependent on the data that is part of a given data segment as opposed to the dataset as a whole and (ii) determining which loss value to calculate is based on this dynamically generated threshold value. As such, the system may reduce underfitting and overfitting of the machine learning model at the segment level, thereby providing enhanced machine learning model performance at the segment level.

Upon generating the respective loss value based on the condition (e.g., whether the absolute value of the difference is (i) anything but less than or equal to the first dynamic hyperparameter value or (ii) less than or equal to the first dynamic hyperparameter value), and subsequent to updating one or more parameters of the machine learning model based on the respective loss value, the machine learning model training routine may continue iteratively. For example, the machine learning model training routine may provide an input feature vector corresponding to a new data point of the segmented dataset as input to the machine learning model. The system may perform similar calculations to the above until the entire dataset has been inputted into the machine learning model. In some embodiments, once the entire dataset has been provided as input into the machine learning model, the system may stop the machine learning model training routine. In other embodiments however, the machine learning model training routine may continue until one or more performance metrics of the machine learning model is satisfied.

At step 414, process 400 (e.g., using one or more components described above) the system may retrain the machine learning model based on a performance metric. For example, in response to a performance metric resulting from training the machine learning model failing to satisfy a threshold performance metric, the machine learning model may be retrained based on a set of updated dynamic hyperparameter values via the dynamic loss function. For instance, the system may determine a performance metric based on results (e.g., outputs) of the machine learning model. For instance, once the machine learning model has been trained, the system may provide test data (e.g., new data that the model has not yet “seen” or been provided as input) to the machine learning model. For example, the test data may include labeled feature vectors that indicate a customer identifier, a current balance, a timestamp, as well as one or more labels indicating an expected output corresponding to the customer. The system may provide the test data to the machine learning model and determine a performance metric of the machine learning model. The performance metric may be based on one or more results (e.g., outputs) generated by the machine learning model's training during or after the training of the machine learning model. For example, the performance metric may be a mean squared error, root mean squared error, r-squared, confusion matrix, precision and recall, f1-score, AU-ROC or other performance metrics. The threshold performance metric may be a predetermined value selected by a user or may be a predetermined value stored within a database that corresponds to the performance metric.

In response to the performance metric failing to satisfy a threshold performance metric, the system may retrain the machine learning model based on a set of updated dynamic hyperparameter values using the dynamic loss function. For example, the system may re-generate the set of dynamic hyperparameter values using an updated quantile value prior to retraining the machine learning model with the dynamic loss function. For example, the updated dynamic hyperparameter values (e.g., re-generated dynamic hyperparameter values) may be generated in a process similar to that as described in steps 408-410, albeit with the updated quantile value(s). For example, the system may retrieve, from a database, new quantile value(s) to be used as a basis for generating the dynamic hyperparameter values. As another example, the system may receive, from a user, new quantile value(s) to be used as a basis for generating the dynamic hyperparameter values. In some embodiments, the system may iteratively retrain the machine learning model until the performance metric successfully satisfies the threshold performance metric, thus enabling the machine learning model to accurately forecast the heterogeneous dataset. In other embodiments, the system may iteratively retrain the machine learning model until a user provides an indication to stop retraining of the machine learning model.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for improving the performance of a machine learning model using heterogeneous datasets via dynamic loss functions, the method comprising: receiving a dataset for training a machine learning model; determining one or more dataset characteristics of the received dataset; in response to determining that the received dataset comprises a heterogeneous dataset characteristic, select a dynamic loss function from a set of loss functions, wherein the dynamic loss function comprises a dynamic hyperparameter that is based on segments of a segmented dataset distribution; performing a segmentation process on the received dataset, to generate a segmented dataset of the received dataset comprising a set of data segments, wherein each data segment corresponds to a sub-dataset of the received dataset; generating a set of dynamic hyperparameter values, based on each data segment of the set of data segments, wherein each dynamic hyperparameter value of the set of dynamic hyperparameter values corresponds to a respective data segment of the set of data segments; providing the received dataset to the machine learning model to train the machine learning model using the dynamic loss function, wherein the dynamic loss function uses the set of dynamic hyperparameter values; and in response to a performance metric resulting from training the machine learning model failing to satisfy a threshold performance metric, retraining the machine learning model based on a set of updated dynamic hyperparameter values via the dynamic loss function, wherein the performance metric fails to satisfy the threshold performance metric.
2. The method of any one of the preceding embodiments, wherein determining whether the received dataset comprises the heterogeneous dataset characteristic further comprises: performing a second segmentation process on the dataset to obtain a second set of data segments, wherein each second data segment of the set of data segments corresponds to a second sub-dataset of the received dataset; determining, for each second data segment of the second set of data segments, a set of outlier values of a target variable within a respective second data segment of the second set of data segments; determining a threshold outlier value of the target variable based on averaging each outlier value of the set of outlier values of each second data segment of the set of data segments; comparing each outlier value of the set of outlier values for each second data segment of the second set of data segments to the threshold outlier value to determine whether the respective outlier value is within a threshold value range of the threshold outlier value; and in response to the respective outlier value being within outside the threshold value range of the threshold outlier value, determining that the dataset comprises the heterogeneous dataset characteristic, wherein the respective outlier value is within outside the threshold value range of the threshold outlier value.
3. The method of any one of the preceding embodiments, wherein determining whether the received dataset comprises the heterogeneous dataset characteristic further comprises: performing a second segmentation process on the dataset to obtain a second set of data segments, wherein each second data segment of the set of data segments corresponds to a second sub-dataset of the received dataset; determining, for each second data segment of the second set of data segments, a set of outlier values of a target variable within a respective second data segment of the second set of data segments; generating an average outlier value, for each second data segment of the second set of data segments, wherein the average outlier value is based on the set of outlier values of the target variable with the respective second data segment of the second set of data segments; comparing, for each second data segment of the second set of data segments, the generated average outlier value to a threshold outlier value; and in response to at least one average outlier value of a second data segment of the second set of data segments failing to satisfy the threshold outlier value, determining that the received dataset comprises the heterogeneous dataset characteristic, wherein the at least one average outlier value of the second data segment of the second set of data segments fails to satisfies the threshold outlier value.
4. The method of any one of the preceding embodiments, wherein determining whether the received dataset comprises the heterogeneous dataset characteristic further comprises: performing a second segmentation process on the dataset to obtain a second set of data segments, wherein each second data segment of the set of data segments corresponds to a second sub-dataset of the received dataset; determining, for each second data segment of the second set of data segments, an average target variable value, based on target variable values, within a respective second data segment of the second set of data segments; computing a difference between (i) a first average target variable value of a first data segment of the second set of data segments and (ii) a second average target variable value of a second data segment of the second set of data segments; and in response to the difference failing to satisfy a threshold value, determining that the received dataset comprises the heterogeneous dataset characteristic, wherein the difference fails to satisfy the threshold value.
5. The method of any one of the preceding embodiments, wherein determining whether the received dataset comprises the heterogeneous dataset characteristic further comprises: performing a second segmentation process on the dataset to obtain a second set of data segments, wherein each second data segment of the set of data segments corresponds to a second sub-dataset of the received dataset; determining, for each second data segment of the second set of data segments, a probability distribution type corresponding to the second data segment of the second set of data segments; and in response to determining that a first probability distribution type corresponding to a first data segment of the second set of data segments is different from a second probability distribution type corresponding to a second data segment of the second set of data segments, determining that the received dataset comprises the heterogeneous dataset characteristic.
6. The method of any one of the preceding embodiments, wherein the set of dynamic hyperparameter values are further based on a quantile value.
7. The method of any one of the preceding embodiments, wherein the quantile value is a user-selected value.
8. The method of any one of the preceding embodiments, wherein generating the set of dynamic hyperparameter values further comprises: selecting a first data segment of the set of data segments; extracting target variable values from the first data segment of the set of data segments; determining a number of target variable values from the first data segment of the set of data segments; generating an N value by multiplying the number of target variable values from the first data segment to the quantile value; and selecting the target variable value, from a sorted list of the target variable values of the first data segment, that corresponds to the N value, wherein the selected target variable value is a first dynamic hyperparameter value for the first data segment of the set of data segments.
9. The method of any one of the preceding embodiments, wherein the set of loss functions comprises the dynamic loss function, a quadratic loss function, a log-loss function, a hinge loss function, a mean absolute error function, a Huber loss function, a log-cosh loss function, and a quantile loss function.
10. The method of any one of the preceding embodiments, where the received dataset provided to the machine learning model is the segmented dataset.
11. The method of any one of the preceding embodiments, wherein training the machine learning model using the dynamic loss function comprises: during a machine learning model training routine: generating a predicted value based on a first datapoint from a first data segment from the segmented dataset; determining a first dynamic hyperparameter value of the set of dynamic hyperparameter values that corresponds to the first data segment; generating a first loss value using the dynamic loss function based on the predicted value and a target value in response to an absolute difference between (i) the predicted value and (ii) the target value being less than or equal to the first dynamic hyperparameter value; and updating one or more weights or biases of the machine learning model based on the first loss value.
12. The method of any one of the preceding embodiments, wherein the first loss value is one half multiplied by square of the target value minus the predicted value.
13. The method of any one of the preceding embodiments, wherein providing the received dataset to the machine learning model to train the machine learning model using the dynamic loss function comprises: during a machine learning model training routine: generating a predicted value based on a first datapoint from a first data segment from the segmented dataset; determining a first dynamic hyperparameter value of the set of dynamic hyperparameter values that corresponds to the first data segment; generating a second loss value using the dynamic loss function based on the predicted value and a target value in response to an absolute difference between (i) the predicted value and (ii) the target value being greater than the first dynamic hyperparameter value; and updating one or more weights or biases of the machine learning model based on the second loss value.
14. The method of any one of the preceding embodiments, wherein the second loss value is the first dynamic hyperparameter value multiplied by a second value, wherein the second value is a difference between the absolute difference between the target value and the predicted value and one half multiplied by the first dynamic hyperparameter value.
15. The method of any one of the preceding embodiments, wherein the machine learning model is a secured machine learning model.
16. The method of any one of the preceding embodiments, wherein the dataset is an encrypted dataset.
17. The method of any one of the preceding embodiments, wherein the method uses homomorphic encryption to process the dataset or train the machine learning model.
18. One or more non-transitory, computer-readable mediums storing instructions that, when executed by a data processing apparatus, cause the data processing apparatus to perform operations comprising those of any of embodiments 1-17.
19. A system comprising one or more processors; and memory storing instructions that, when executed by the processors, cause the processors to effectuate operations comprising those of any of embodiments 1-17.
20. A system comprising means for performing any of embodiments 1-17.

What is claimed is:

1. A system for improving secured model performance using heterogeneous datasets via dynamic loss functions within a secured computing environment, the system comprising:
one or more processors; and
a non-transitory, computer-readable medium comprising instructions recorded thereon that, when executed by the one or more processors, cause operations comprising:
receive, during a secured model training routine, an encrypted dataset for training a secured model;
determine whether the encrypted dataset exhibits a heterogeneous characteristic;
in response to determining that the encrypted dataset exhibits the heterogeneous characteristic, select a dynamic loss function, wherein the dynamic loss function is associated with (i) heterogeneous dataset processing (ii) and comprises a dynamic hyperparameter that changes with respect to each segment of a segmented dataset distribution;
perform a segmentation process on the encrypted dataset to generate a segmented dataset of the encrypted dataset comprising a set of data segments, wherein each data segment corresponds to a sub-dataset of the encrypted dataset;
generate a set of dynamic hyperparameter values, based on each data segment of the set of data segments, wherein each dynamic hyperparameter value of the set of dynamic hyperparameter values corresponds to (i) a respective data segment of the set of data segments and (ii) a quantile value;
provide the encrypted dataset to the secured model, during the secured model training routine, to train the secured model using the dynamic loss function, wherein the dynamic loss function is based on the set of dynamic hyperparameter values;
determine a performance metric based on results of the secured model training routine, wherein the performance metric is related to the quantile value; and
in response to the performance metric failing to satisfy a threshold performance metric value, re-generating the set of dynamic hyperparameter values using an updated quantile value prior to retraining the secured model with the dynamic loss function.

2. A method for improving secured model performance using heterogeneous datasets via dynamic loss functions, the method comprising:
receiving an encrypted dataset for training a secured model;
determining one or more dataset characteristics of the encrypted dataset;
in response to determining that the encrypted dataset comprises a heterogeneous dataset characteristic, select a dynamic loss function from a set of loss functions, wherein the dynamic loss function comprises a dynamic hyperparameter that is based on segments of a segmented dataset distribution;
performing a segmentation process on the encrypted dataset, to generate a segmented dataset of the encrypted dataset comprising a set of data segments, wherein each data segment corresponds to a sub-dataset of the encrypted dataset;
generating a set of dynamic hyperparameter values, based on each data segment of the set of data segments, wherein each dynamic hyperparameter value of the set of dynamic hyperparameter values corresponds to a respective data segment of the set of data segments;
providing the encrypted dataset to the secured model to train the secured model using the dynamic loss function, wherein the dynamic loss function uses the set of dynamic hyperparameter values; and
in response to a performance metric resulting from training the secured model failing to satisfy a threshold performance metric, retraining the secured model based on a set of updated dynamic hyperparameter values via the dynamic loss function, wherein the performance metric fails to satisfy the threshold performance metric.

3. The method of claim 2, wherein determining whether the encrypted dataset comprises the heterogeneous dataset characteristic further comprises:
performing a second segmentation process on the encrypted dataset to obtain a second set of data segments, wherein each second data segment of the set of data segments corresponds to a second sub-dataset of the encrypted dataset;
determining, for each second data segment of the second set of data segments, a set of outlier values of a target variable within a respective second data segment of the second set of data segments;
determining a threshold outlier value of the target variable based on averaging each outlier value of the set of outlier values of each second data segment of the set of data segments;
comparing each outlier value of the set of outlier values for each second data segment of the second set of data segments to the threshold outlier value to determine whether the respective outlier value is within a threshold range of the threshold outlier value; and
in response to the respective outlier value being outside the threshold range of the threshold outlier value, determining that the dataset comprises the heterogeneous dataset characteristic, wherein the respective outlier value is outside the threshold range of the threshold outlier value.

4. The method of claim 2, wherein determining whether the encrypted dataset comprises the heterogeneous dataset characteristic further comprises:
performing a second segmentation process on the encrypted dataset to obtain a second set of data segments, wherein each second data segment of the set of data segments corresponds to a second sub-dataset of the encrypted dataset;
determining, for each second data segment of the second set of data segments, a set of outlier values of a target variable within a respective second data segment of the second set of data segments;
generating an average outlier value, for each second data segment of the second set of data segments, wherein the average outlier value is based on the set of outlier values of the target variable with the respective second data segment of the second set of data segments;
comparing, for each second data segment of the second set of data segments, the generated average outlier value to a threshold outlier value; and
in response to at least one average outlier value of a second data segment of the second set of data segments satisfying the threshold outlier value, determining that the encrypted dataset comprises the heterogeneous dataset characteristic, wherein the at least one average outlier value of the second data segment of the second set of data segments satisfies the threshold outlier value.

5. The method of claim 2, wherein determining whether the encrypted dataset comprises the heterogeneous dataset characteristic further comprises:
performing a second segmentation process on the encrypted dataset to obtain a second set of data segments, wherein each second data segment of the set of data segments corresponds to a second sub-dataset of the encrypted dataset;
determining, for each second data segment of the second set of data segments, an average target variable value, based on target variable values, within a respective second data segment of the second set of data segments;
computing a difference between (i) a first average target variable value of a first data segment of the second set of data segments and (ii) a second average target variable value of a second data segment of the second set of data segments; and
in response to the difference failing to satisfy a threshold value, determining that the encrypted dataset comprises the heterogeneous dataset characteristic, wherein the difference fails to satisfy the threshold value.

6. The method of claim 2, wherein determining whether the encrypted dataset comprises the heterogeneous dataset characteristic further comprises:
performing a second segmentation process on the encrypted dataset to obtain a second set of data segments, wherein each second data segment of the set of data segments corresponds to a second sub-dataset of the encrypted dataset;
determining, for each second data segment of the second set of data segments, a probability distribution type corresponding to the second data segment of the second set of data segments; and
in response to determining that a first probability distribution type corresponding to a first data segment of the second set of data segments is different from a second probability distribution type corresponding to a second data segment of the second set of data segments, determining that the encrypted dataset comprises the heterogeneous dataset characteristic.

7. The method of claim 2, wherein the set of dynamic hyperparameter values are further based on a quantile value.

8. The method of claim 7, wherein the quantile value is a user-selected value.

9. The method of claim 7, wherein generating the set of dynamic hyperparameter values further comprises:
selecting a first data segment of the set of data segments;
extracting target variable values from the first data segment of the set of data segments;
determining a number of target variable values from the first data segment of the set of data segments;
generating an N value by multiplying the number of target variable values from the first data segment to the quantile value; and
selecting the target variable value, from a sorted list of the target variable values of the first data segment, that corresponds to the N value, wherein the selected target variable value is a first dynamic hyperparameter value for the first data segment of the set of data segments.

10. The method of claim 2, wherein the set of loss functions comprises the dynamic loss function, a quadratic loss function, a log-loss function, a hinge loss function, a mean absolute error function, a Huber loss function, a log-cosh loss function, and a quantile loss function.

11. The method of claim 2, wherein the encrypted dataset provided to the secured model is the segmented dataset.

12. The method of claim 2, wherein training the secured model using the dynamic loss function comprises:
during a secured model training routine:
generating a predicted value based on a first datapoint from a first data segment from the segmented dataset;
determining a first dynamic hyperparameter value of the set of dynamic hyperparameter values that corresponds to the first data segment;
generating a first loss value using the dynamic loss function based on the predicted value and a target value in response to an absolute difference between (i) the predicted value and (ii) the target value being less than or equal to the first dynamic hyperparameter value; and
updating one or more weights or biases of the secured model based on the first loss value.

13. The method of claim 12, wherein the first loss value is one half multiplied by square of the target value minus the predicted value.

14. The method of claim 2, wherein providing the encrypted dataset to the secured model to train the secured model using the dynamic loss function comprises:
during a secured model training routine:
generating a predicted value based on a first datapoint from a first data segment from the segmented dataset;
determining a first dynamic hyperparameter value of the set of dynamic hyperparameter values that corresponds to the first data segment;
generating a second loss value using the dynamic loss function based on the predicted value and a target value in response to an absolute difference between (i) the predicted value and (ii) the target value being greater than the first dynamic hyperparameter value; and
updating one or more weights or biases of the secured model based on the second loss value.

15. The method of claim 14, wherein the second loss value is the first dynamic hyperparameter value multiplied by a second value, wherein the second value is a difference between (i) the absolute difference between the target value and the predicted value and (ii) one half multiplied by the first dynamic hyperparameter value.

16. One or more non-transitory computer-readable media comprising instructions that, when executed by one or more processors, cause operations comprising:
determining one or more dataset characteristics of a received dataset;
in response to determining that the received dataset comprises a first dataset characteristic, select a first loss function from a set of loss functions, wherein the first loss function comprises a hyperparameter that is based on segments of a segmented dataset distribution;
to generating a segmented dataset of the received dataset comprising a set of data segments, wherein each data segment corresponds to a sub-dataset of the received dataset;
generating a set of hyperparameter values, based on each data segment of the set of data segments, wherein each hyperparameter value of the set of hyperparameter values corresponds to a respective data segment of the set of data segments;
providing the received dataset to a machine learning model to train the machine learning model using the first loss function, wherein the first loss function uses the set of hyperparameter values; and
in response to a performance metric resulting from training the machine learning model failing to satisfy a threshold performance metric, retraining the machine learning model based on a set of updated hyperparameter values via the first loss function.

17. The media of claim 16, wherein determining whether the received dataset comprises the first dataset characteristic further comprises:
performing a segmentation process on the dataset to obtain a second set of data segments, wherein each second data segment of the set of data segments corresponds to a second sub-dataset of the received dataset;
determining, for each second data segment of the second set of data segments, a set of outlier values of a target variable within a respective second data segment of the second set of data segments;
determining a threshold outlier value of the target variable based on averaging each outlier value of the set of outlier values of each second data segment of the set of data segments;
comparing each outlier value of the set of outlier values for each second data segment of the second set of data segments to the threshold outlier value to determine whether the respective outlier value is within a threshold range of the threshold outlier value; and
in response to the respective outlier value being outside the threshold range of the threshold outlier value, determining that the dataset comprises the first dataset characteristic.

18. The media of claim 16, wherein generating the set of hyperparameter values further comprises:
selecting a first data segment of the set of data segments;
extracting target variable values from the first data segment of the set of data segments;
determining a number of target variable values from the first data segment of the set of data segments;
generating an N value by multiplying the number of target variable values from the first data segment to a quantile value; and
selecting the target variable value, from a sorted list of the target variable values of the first data segment, that corresponds to the N value, wherein the selected target variable value is a first hyperparameter value for the first data segment of the set of data segments.

19. The media of claim 16, wherein training the machine learning model using the first loss function comprises:
during a machine learning model training routine:
generating a predicted value based on a first datapoint from a first data segment from the segmented dataset;
determining a first hyperparameter value of the set of hyperparameter values that corresponds to the first data segment;
generating a first loss value using the first loss function based on the predicted value and a target value in response to an absolute difference between (i) the predicted value and (ii) the target value being less than or equal to the first hyperparameter value; and
updating one or more weights or biases of the machine learning model based on the first loss value.

20. The media of claim 16, wherein training the machine learning model using the first loss function comprises:
during a machine learning model training routine:
generating a predicted value based on a first datapoint from a first data segment from the segmented dataset;
determining a first hyperparameter value of the set of hyperparameter values that corresponds to the first data segment;
generating a second loss value using the first loss function based on the predicted value and a target value in response to an absolute difference between (i) the predicted value and (ii) the target value being greater than the first hyperparameter value; and
updating one or more weights or biases of the machine learning model based on the second loss value.
